(19) United States
(12) Patent Application Publication
(10) Pub. No.: US 2014/0174613 A1
(43) Pub. Date: Jun. 26, 2014

(54) TYRE COMPRISING SINGLE-STRIP AUDIBLE WEAR INDICATORS

(71) Applicants: Antoine Paturle, Clermont-Ferrand Cedex 9 (FR); Jean-Jacques Azam, Clermont-Ferrand Cedex 9 (FR)

(72) Inventors: Antoine Paturle, Clermont-Ferrand Cedex 9 (FR); Jean-Jacques Azam, Clermont-Ferrand Cedex 9 (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 14/126,157

(22) PCT Filed: Jun. 15, 2012
(86) PCT No.: PCT/FR2012/051341

§ 371 Date: Jan. 24, 2014

(30) Foreign Application Priority Data
Jun. 15, 2011 (FR) 1155235

(51) Int. Cl. B60C 11/24

(52) U.S. Cl. CPC B60C 11/24
USPC 152/154.2

(57) ABSTRACT

A tyre includes a first-threshold projection and a second-threshold projection. The first-threshold projection extends radially from a bottom of a circumferential groove of the tyre. The first-threshold projection is arranged such that, once the tyre has exceeded a first wear threshold, the first-threshold projection comes into contact with a ground surface as the first-threshold projection passes through a contact area in which the tyre contacts the ground surface. The second-threshold projection extends radially from a bottom of a circumferential groove of the tyre. The second-threshold projection is arranged such that, once the tyre has exceeded a wear threshold indicative of a more advanced wear than the first wear threshold, the second-threshold projection comes into contact with the ground surface as the second-threshold projection passes through a contact area in which the tyre contacts the ground surface. A plurality of threshold projections may be evenly distributed circumferentially about the tyre.

The present invention relates to a tyre fitted with audible wear indicators. It applies notably, but without being restricted thereto, to tyres for vehicles of any type, passenger car or heavy goods vehicle.

As a tyre gradually runs along the ground, its tread that is in contact with the ground becomes worn away through friction. For obvious safety reasons it is important to replace a tyre before its tread wear becomes too pronounced and carries the risk of having an impact on performance, particularly wet grip.

Document FR 2 937 902 discloses a tyre comprising, in addition to the aforementioned legal limit wear indicators, evenly distributed audible wear indicators consisting of acoustic cavities. Each cavity is delimited in part by two strips placed in the bottom of a groove of the tyre. Each cavity is configured in such a way as to be closed by the ground in a substantially airtight manner in such a way as to temporarily trap air as it passes through the contact area in which the tyre is in contact with the ground. Under the effect of the deformation of the tyre in the contact area, this air trapped in the cavity is compressed and then suddenly expands as it leaves the contact area and the cavity therefore opens. This expansion of the air causes a specific noise which occurs only when the tyre has been worn beyond a certain threshold. Thus, even if the driver does not take the trouble to perform a regular visual inspection of the condition of the surface of his tyres, he is informed of excessive tyre wear when, as he is driving, the specific noise is detected.

However, the acoustic cavities, because of the arrangement of the strips in the grooves, may impair the performance of the tyre as compared with a tyre that has no such acoustic cavities, notably in terms of their ability to remove water via the grooves and therefore in terms of grip, chiefly because of the high number of strips used to delimit the various cavities. The more advanced the state of wear of the tyre, the more this water removal performance is impaired.

Further, the tyre and its mould are complicated to design, notably because of the high number of strips used to delimit the various cavities. This is because if an indicator is situated at the same position as part of the tread pattern, such as an open cut opening into the cavity delimited by the two strips, the cavity does not emit the expected noise because it is not closed in such a way as to trap the air and cannot therefore detect wear. On the other hand, if a strip is situated at the same position as a particular zone of the mould, such as the join between two segments, the strip is mechanically weakened by the numerous openings and closings of the mould during the numerous curings of the tyres. If, in addition, the indicators are to be evenly distributed, it then becomes difficult, if not impossible, to design empirically a tyre in which all the wear indicators meet these requirements of interaction with the tread pattern and mould elements.

It is a notable object of the invention to provide a tyre provided with audible wear indicators that have little influence on the performance and design of the tyre.

To this end, one subject of the invention is a tyre comprising at least:

two projections, referred to as first-threshold projections, which are circumferentially successive, each of these projections extending radially from the bottom of a circumferential groove of the tyre and being arranged in such a way as to come into contact with the ground as it passes through the contact area in which the tyre makes contact with the ground once the tyre has exceeded a first wear threshold;

another projection extending radially from the bottom of a circumferential groove of the tyre, the said other projection being arranged in such a way as to come into contact with the ground as it passes through the contact area in which the tyre comes into contact with the ground once the tyre has exceeded a wear threshold indicative of more advanced wear than the first wear threshold;

in which tyre:

the first-threshold projections are evenly circumferentially distributed about the tyre.

Surprisingly, the inventors have discovered that the first-threshold projections are enough to cause a characteristic noise when the tyre is being driven on once the first tyre wear threshold has been reached. The inventors are putting forward the hypothesis whereby this noise is generated by at least two distinct physical phenomena which have a synergistic effect. On the one hand, once the first wear threshold is reached, the noise is generated by impact of the projection with the ground. On the other hand, once the wear threshold is reached, as the tyre runs along the ground, a plug of air is likely to be formed in the groove ahead of the projection because of the high relative speed between the tyre and the air through which the tyre is moving. Air is therefore temporarily trapped in a space confined between this plug and the projection as this space passes through the contact area in which the tyre is in contact with the ground. Under the effect of the deformation of the tyre in the contact area, this air trapped in this space is compressed and suddenly expands as it leaves the contact area when the tread breaks contact with the ground at the rear of the tyre.

In the invention, because each wear indicator consists of a single projection rather than of two projections forming a cavity that is closed to air as it passes through the contact area in which the tyre is in contact with the ground, for the same number of wear indicators, the number of projections arranged in the groove or grooves is halved. The potential loss of performance generated by the projections is thus limited. There is therefore relatively little impact on the grip performance of the tyre.

Because of the lower number of projections, the design of the tyre and of its mould also becomes simpler because, since each indicator does not form a closed cavity, there is no need to avoid interactions with the other parts of the tread pattern or of the mould of the tyre.

Because the projections are arranged in the grooves, the noise emitted as a result of the projections is amplified by comparison with acoustic wear indicators positioned elsewhere in the tread. The emitted noise is amplified by a flared resonator formed by the tyre and the ground once the acoustic wear indicator has passed through the contact area. This amplification through a flared resonator effect is at a maximum when the projections are preferably arranged axially in a central part of the tread. The central part of the tread means the region in the tread that extends axially, i.e. parallel to the axis of rotation of the tyre, over approximately half the width of this tread under nominal load and pressure conditions and that is centred relative to the central median plane of the tyre.

Even if the driver does not take the trouble to regularly inspect the condition of the surface of his tyres visually, he will be informed of the crossing of the wear threshold when, as he is driving, the characteristic noise is detected.

Further, because the first-threshold projections are evenly circumferentially distributed about the tread of the tyre, the noise emitted when the first wear threshold is exceeded has noticeable frequency characteristics. Specifically, spectral analysis of the noise emitted once the wear threshold has been exceeded reveals, within the frequency domain, a Dirac comb that can be readily identified from all the parasitic noises such as the road noise of the tyre, the wind, the noise of the engine or the noise of the associated drivetrain. Use may be made of a method for detecting the wear of the tyre according to the invention, like that described in application PCT/FR2010/052584. As an alternative, other methods may be used.

For preference, use is made of a processing unit and of one or more detection microphones, which are connected to a processing unit capable of discerning the noise from the running noise and of informing the driver that his tyres are worn.

What is meant by “evenly circumferentially distributed projections” is that each projection is situated substantially the same angular distance away from the two projections adjacent to it whether or not they are arranged in the same groove. In other words, the evenly distributed projections have the same angular separation one from the next. In the case of just one projection, this single projection is considered to be evenly circumferentially distributed. This is because in this case, the adjacent projections are formed by the projection itself.

The projections of the tyre according to the invention differ from the anti-chippings blocks of rubber intended to prevent stone chippings from becoming wedged in the grooves of tyres of heavy goods-type vehicles. Indeed unlike these blocks of rubber, the projections of the tyre according to the invention have an acoustic main function rather than an “anti-chippings” function. The number of sets of projections corresponding to a determined wear threshold is generally between 2 and 30.

It is preferably at most 10 and highly preferably 8 to 10 sets for a passenger vehicle. It is generally at most 22 and preferably 12 to 20 sets for a utility heavy goods vehicle. As an option, sets with single projections will be used. The number of projections on the tyre will then therefore preferably be less than or equal to 20, or even 10 whereas the number of these anti-chippings blocks is in excess of 50 and preferably in excess of 100. The projections are not arranged on each section of the tread pattern of the tyre according to the invention, unlike the anti-chippings blocks which are arranged on each section of the tread pattern. Thus, the tyre according to the invention has tread patterns that have no projections.

The circumferential width of a rubber projection is generally between 2 and 15 mm (millimetres) and preferably between 3 and 10 mm. These values are suitable for generating sufficient running noise.

The circumferential position of a projection can be considered to be that corresponding to the median position of its circumferential width.

For preference, the projections are made of rubber and moulded with the rest of the tyre.

Advantageously, a wear threshold for the tyre that is more advanced than the first wear threshold is a legal limit wear threshold.

Thus, the first-threshold projections allow the driver to be alerted early to the fact that he will shortly reach the legal limit wear threshold.

In one embodiment, the tyre comprises two circumferentially successive first-threshold projections arranged in the bottom of one and the same groove.

In another embodiment, the tyre comprises two circumferentially successive first-threshold projections arranged in the bottom of different grooves.

In one embodiment, the tyre comprises a set of first-threshold projections arranged in the bottom of different grooves, each first-threshold projection of the set being more or less axially aligned with each other first-threshold projection of the set.

All the above features relating to the distribution of the first-threshold projections may also be applied to the projections of the other thresholds.

In particular, the tyre may comprise at least one legal limit threshold projection per groove and, for preference, several legal limit threshold projections per groove.

In an alternative form, the tyre comprises a set of legal limit threshold projections arranged in the bottom of different grooves, each legal limit threshold projection of the set being substantially axially aligned with each other legal limit threshold projection of the set.

In another alternative form, the tyre comprises two legal limit threshold projections arranged in the bottom of different grooves and axially offset from one another.

For preference, the projection or projections for one and the same threshold are evenly circumferentially distributed about the tyre.

Once the wear threshold has been reached, the projections of this threshold, for example legal limit wear indicators, behave like the first-threshold projections. The noise emitted by the projections of this threshold therefore, in the frequency domain, just like with the noise generated by the first-threshold projections, has noticeable frequency characteristics. Spectral analysis of this noise reveals, in the frequency domain, just like with the noise generated by the first-threshold projections, a Dirac comb that can be easily identified.

Advantageously, all the projections are evenly circumferentially distributed about the tyre.

Thus, spectral analysis of the noise generated by the projections when the highest threshold has been exceeded, generates a single Dirac comb.

As an option, the projections are arranged in such a way that, whatever the tyre wear, two circumferentially successive projections of one and the same groove and the groove delimit a space open to the air as the two projections pass through the contact area in which the tyre is in contact with the ground.

Advantageously, when the tyre is new, each circumferential groove has a predetermined depth and the height of each projection of each threshold is substantially equal to the difference between the predetermined depth of the groove and the wear threshold.

Optionally, the projection or projections extend partially transversally to the bottom of the groove or grooves so that the tyre comprises at least one canal for fluidic passage between the projection or projections and at least one wall delimiting the groove or grooves.

Thus, when a projection is too close to another projection, the fluidic passage makes it possible, once the most advanced threshold has been exceeded, to prevent the projections from delimiting a cavity that is closed as they pass through the contact area in which the tyre is in contact with the ground. Because of the noise it would produce, such a cavity would destroy the even distribution of the projections and alter the characteristics of the noise generated by the projections.

Further, the fluidic passage improves the drainage of water from the grooves and therefore the performance of the tyre.

However, one or all of the projections may also extend transversally over the entire width of a circumferential groove, the projections, distribution preferably being such that no acoustic cavity is created between two successive projections. This is because it has actually been found that the acoustic effect generated by a projection is notably greater when this projection extends transversally across the entire width of a circumferential groove. When this rubber projection comes into contact with the ground (the tyre being worn at least down as far as the corresponding wear threshold), the circumferential groove becomes closed by the ground at the rubber projection delimiting an upstream space and a downstream space of this groove which do not communicate with one another at the rubber projection. It is found that this notably increases the acoustic effect.

One or each rubber projection may be solid i.e. have no cavity. Alternatively, each projection, for example each first-threshold projection, may comprise at least one cavity formed in the projection, the cavity being configured in such a way that, when the first threshold has been exceeded, it:

opens radially to the outside of the tyre, and

is closed by the ground in a substantially airtight manner as it passes through the contact area in which the tyre is in contact with the ground.

Typically, the cavity does not extend as far as the bottom of the circumferential groove, the volume of this small cavity being typically notably less than 250 mm³ (millimetres cubed), for example less than 150 mm³.

Such a cavity is an acoustic cavity. The noise it generates, although limited, combines with the noise generated by the projections and gives a noise that is amplified in comparison with a projection that has no cavity.

Further, the cavity allows the first-threshold projection to be distinguished visually from the legal limit wear indicator.

Finally, such a cavity does not penalize tyre performance or make it more complicated to design.

In one embodiment, each projection of one threshold is circumferentially separated from each projection of another threshold.

In another embodiment, each projection of one threshold is immediately adjacent to a projection of another threshold, which has the advantage that these two projections do not between them define a closed cavity likely to disrupt the detection of the expected noise.

Furthermore, the number of locations for the first-threshold and second-threshold projections is reduced. The wear indicators therefore have little if any impact on the grip performance of the tyre.

When a projection corresponding to a determined wear threshold is not immediately adjacent to another projection, it typically also constitutes a wear indicator for the higher wear thresholds. By contrast, if a projection is immediately adjacent to another threshold corresponding to a higher wear threshold, when the latter wear threshold is reached, the two immediately adjacent projections then form just one single projection, therefore acting as a single wear indicator, corresponding to that threshold (rather than two juxtaposed indicators).

In one embodiment, the tyre comprises at most 12 projections, preferably at most 8 projections, each able to come into contact with the ground as they respectively pass through the contact area in which the tyre is in contact with the ground once a second wear threshold, more advanced than the first threshold, has been exceeded.

In another embodiment, the tyre comprises at most 4 first-threshold projections, and preferably at most 3 first-threshold projections.

In the above embodiments, the number of audible wear indicators and therefore the influence they have on tyre grip performance are limited as far as possible.

The invention will be better understood from reading the description which will follow, which is given solely by way of nonlimiting example and made with reference to the drawings in which:

### DETAILED DESCRIPTION OF EMBODIMENTS OF THE INVENTION

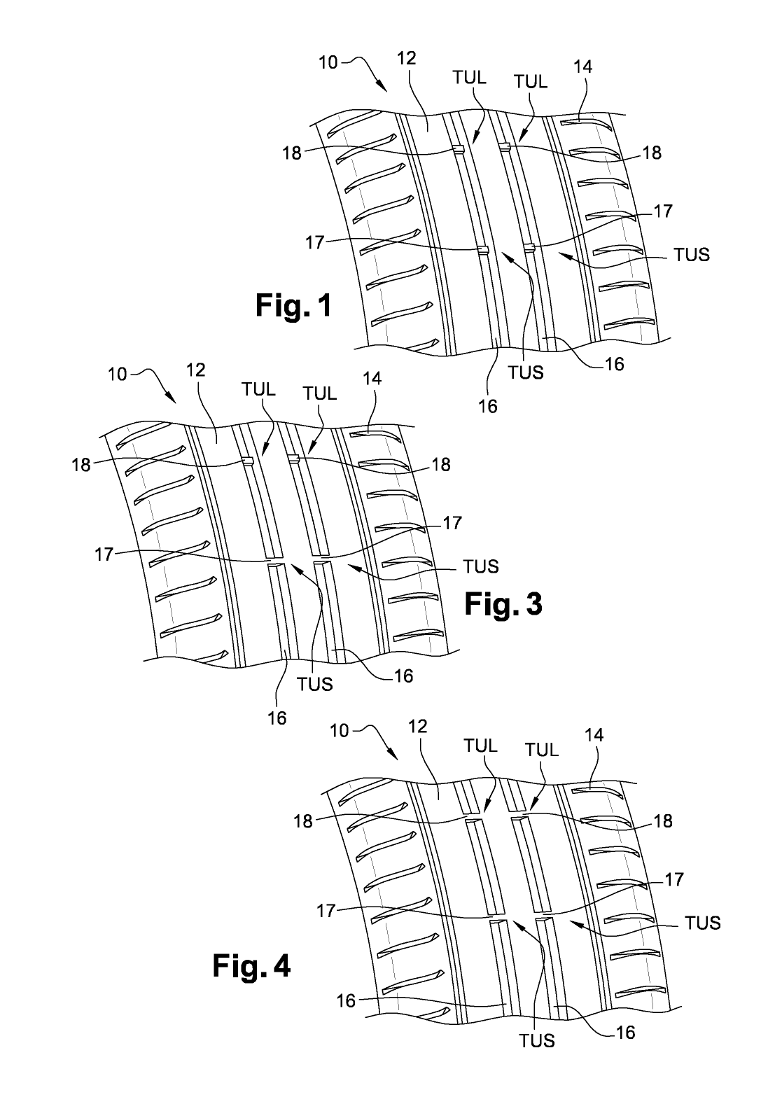

FIG. 1 is a perspective view of a tyre in a new state according to a first embodiment of the invention;

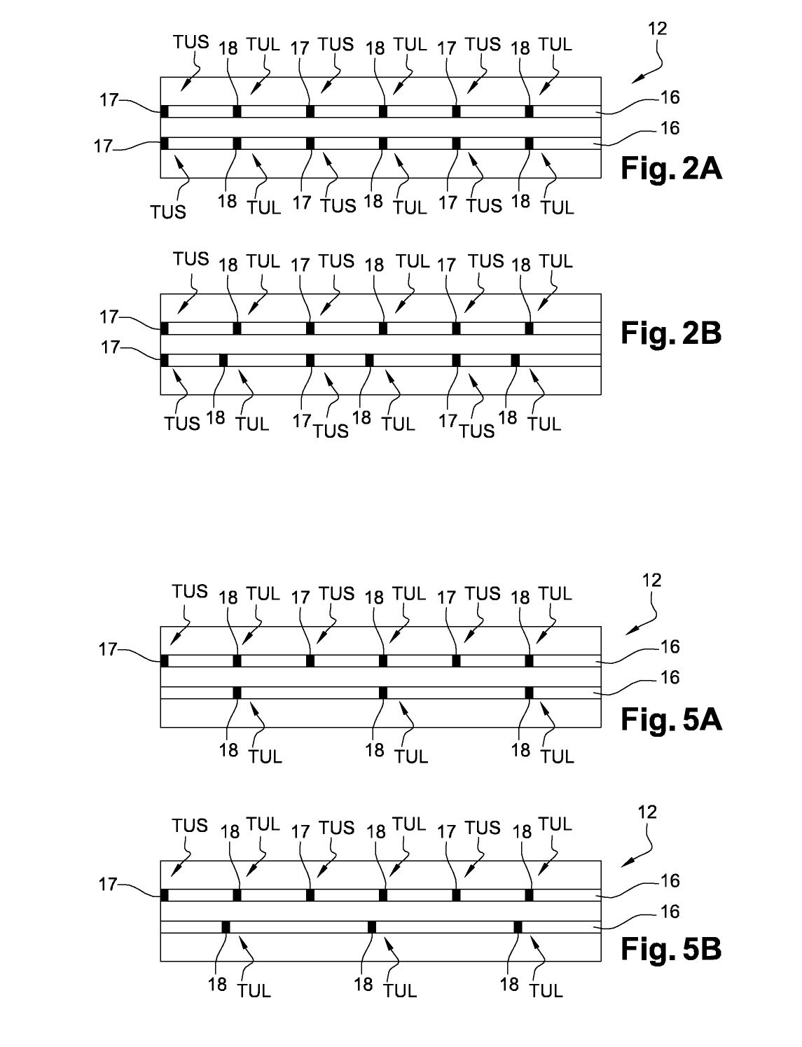

FIG. 2A schematically illustrates a developed tread of the tyre of FIG. 1;

FIG. 2B schematically illustrates a developed tread of an alternative form of the tread of FIG. 2A;

FIG. 3 is a perspective view of the tyre of FIG. 1 in a condition in which it is worn beyond a first predetermined radial wear threshold;

FIG. 4 is a perspective view of the tyre of FIG. 1 in a condition in which it is worn beyond a second predetermined radial wear threshold;

FIG. 5A is similar to FIG. 2 and illustrates a developed tread of a tyre according to a second embodiment of the invention;

FIG. 5B schematically illustrates a developed tread of an alternative form of the tread of FIG. 5A;

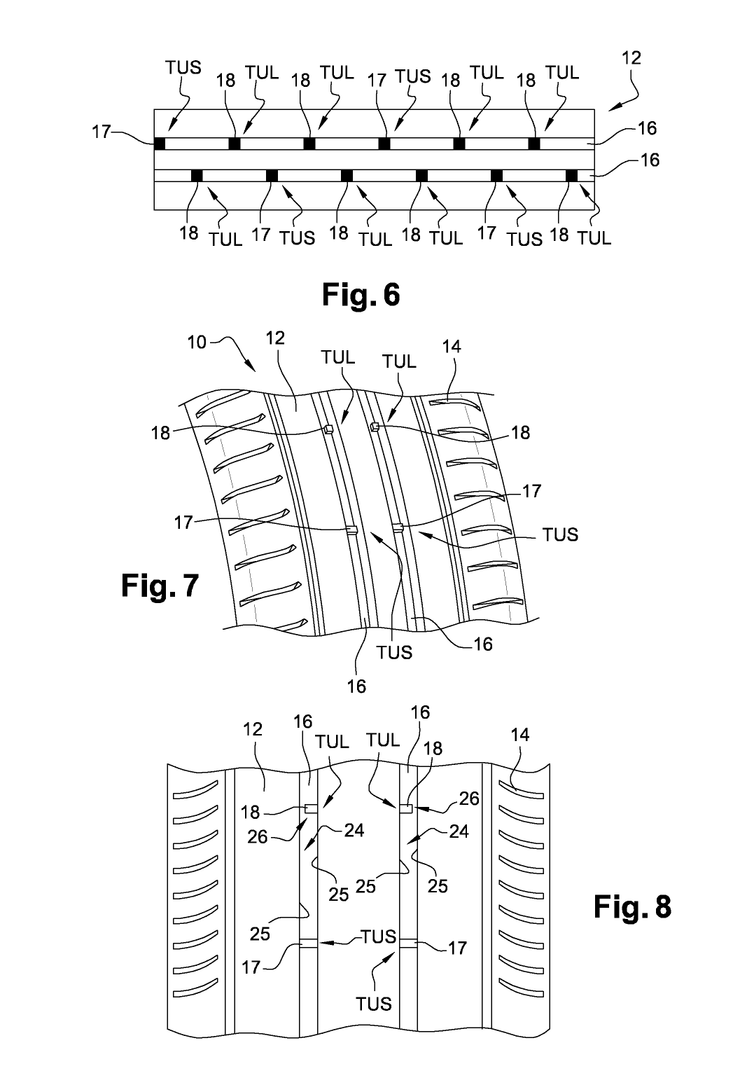

FIG. 6 is similar to FIG. 2 and illustrates a developed tread of a tyre according to a third embodiment of the invention;

FIG. 7 is a view analogous to that of FIG. 1 of a tyre according to a fourth embodiment of the invention;

FIG. 8 is a plan view of a tread of the tyre of FIG. 7;

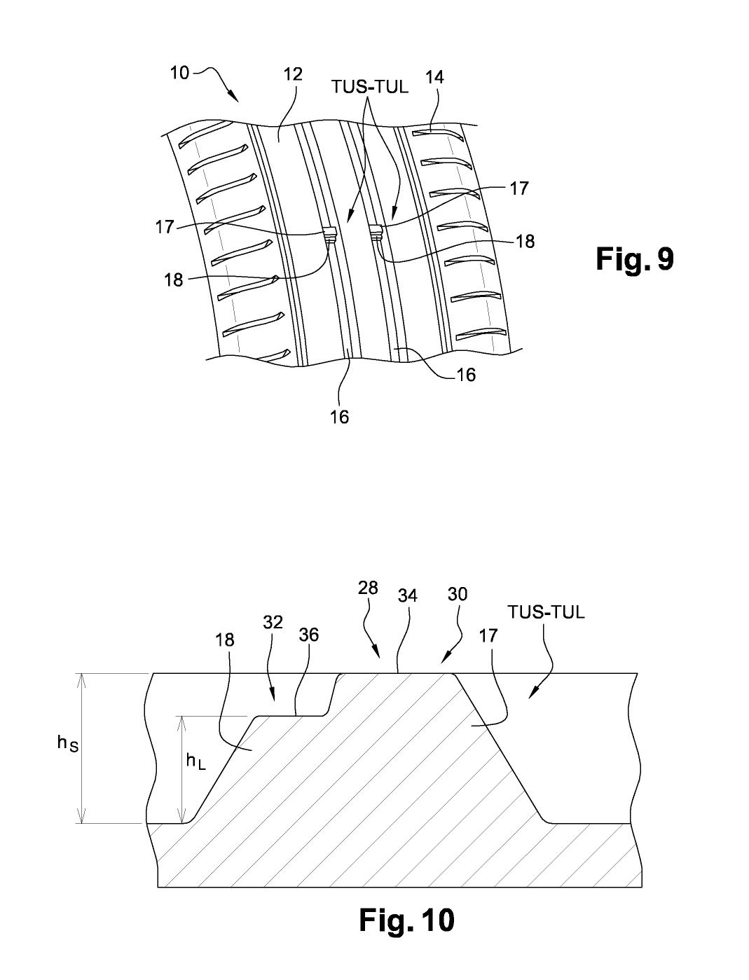

FIG. 9 is a view analogous to that of FIG. 1 of a new tyre according to a fifth embodiment of the invention;

FIG. 10 is a view in axial section in a plane passing through a groove of a tread of the tyre of FIG. 9 which has been worn down to a first wear threshold;

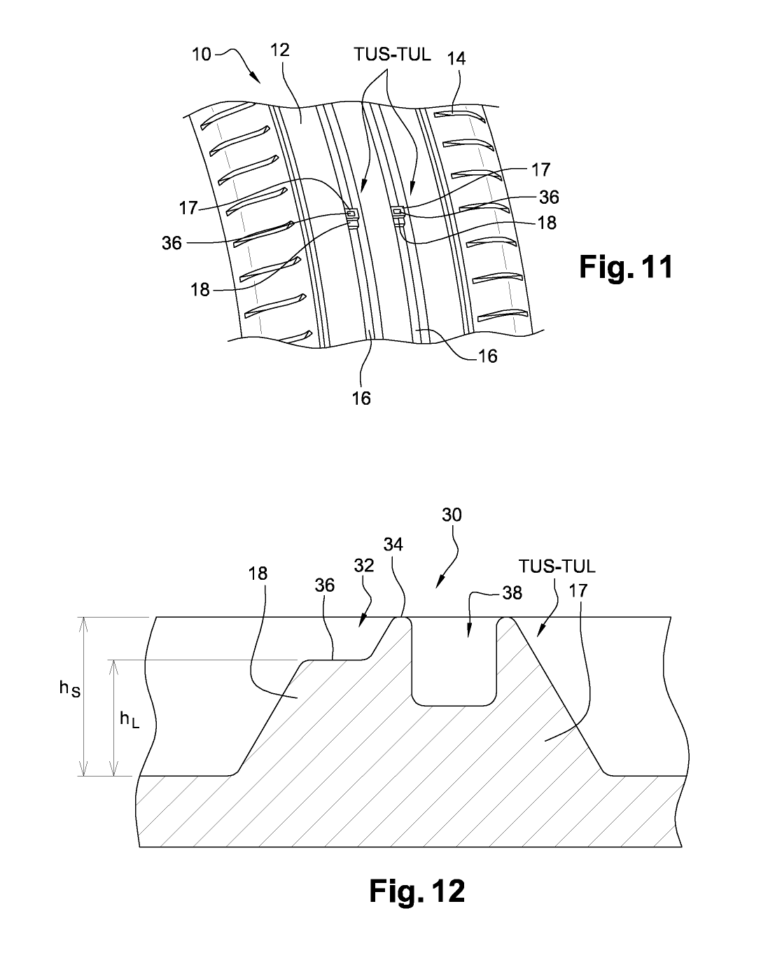

FIG. 11 is a view analogous to that of FIG. 1 of a new tyre according to a sixth embodiment of the invention;

FIG. 12 is a view in axial section in a plane passing through a groove of a tread of the tyre of FIG. 11 which has been worn down to a first wear threshold.

FIG. 1 depicts a tyre in the new condition according to a first embodiment of the invention, and denoted by the general reference 10. The tyre 10 is intended for a passenger vehicle. The tyre 10 is substantially of revolution about an axis.

The tyre 10 comprises a tread 12 of substantially toroidal shape, the external surface of which has tread patterns 14. In particular, the tread 12 comprises two circumferential and parallel grooves 16 cut into the surface of the tyre, having a predetermined depth H when the tyre 10 is new. The depth H of these grooves 16 is of the order of 8 mm and their width is of the order of 10 mm.

The tyre comprises audible wear indicators TUS indicating a first wear threshold SS. The depth of each groove 16 when the threshold SS is reached is set at 2.2 mm, which corresponds to a threshold SS=5.8 mm. Each audible wear indicator TUS is made up of a rubber projection 17, referred to as first-threshold projection, arranged transversally in the bottom of the groove 16 in which it is situated and extending radially from the bottom of this groove 16. When the tyre is new, each projection 17 has a predetermined height h_{S} substantially equal to the difference between the height H of the grooves 16 and the threshold SS.

The tyre 10 comprises wear indicators TUL (the designation TUL, rather than TUS, indicating a second wear threshold SL which corresponds to the legal limit wear threshold for the tyre). The depth of each groove 16 when the threshold SL is reached is set at 1.6 mm, which corresponds to a threshold SL=6.4 mm. Each wear indicator TUL is made up of a rubber projection 18, referred to as a second-threshold projection, arranged transversally in the bottom of the groove 16 in which it is situated and extending radially from the bottom of this groove 16. When the tyre is new, each projection 18 has a predetermined height h_{L}=1.6 mm essentially equal to the difference between the height H of the grooves 16 and the threshold SL.

The second threshold SL is reached after the first threshold SS. In other words, the threshold SL is more advanced than the threshold SS. The threshold SL is reached when the tyre wear exceeds the wear at which the threshold SS is reached. In this particular instance, the height h_{S} is greater than the height h_{L}.

Thus, in this embodiment, the threshold SS corresponds to wear beyond which the tyre displays performance that could be impaired on a wet road surface. The threshold SL itself corresponds to wear beyond which the tyre no longer meets the legal requirements.

Each first-threshold projection 17 is circumferentially separated from each second-threshold SL projection 18. In other words, the projections 18 and 17 do not touch.

When the tyre 10 is new, as has been depicted in FIG. 1, the height of the projections 17, 18 is smaller than the depth of the grooves 16 so that each indicator TUS, TUL has a space above the projections 17, 18, i.e. at the top of the projections 17, 18. Thus, even when the tread is in contact with flat smooth ground, the ground does not come into contact with the projections 17, 18.

The projections 17, 18 are arranged in such a way that, whatever the radial wear of the tyre 10, two circumferentially successive projections 17, 18 of one and the same groove 16 and the groove 16 delimit a space open to the air as they pass through the contact area in which the tyre 10 is in contact with the ground. The pairs of projections 17, 18 concerned comprise two projections 17, two projections 18 or alternatively one projection 18 and one projection 17, depending on the distribution of the indicators TUS, TUL. In this particular instance, the distance separating two circumferentially successive projections 17, 18 of one and the same groove 16 is greater than a predetermined distance, in this instance the length of the contact area, so that even beyond the threshold SS and/or SL, the projections 17, 18 and the groove 16 form a space which remains open to the air as they pass through the contact area in which the tyre 10 is in contact with the ground.

FIG. 2A depicts a development of the tread of the tyre of FIG. 1.

The tyre 10 comprises sets of projections 17, 18, these respectively being sets of first-threshold and second-threshold SS, SL projections, arranged at the bottom of different grooves 16. In this particular instance, each set of first-threshold SS projections comprises two projections 17 and each set of second-threshold SL projections comprises two projections 18. Each projection 17, 18 of each set is more or less axially aligned with each other projection 17, 18 of the set.

The first-threshold SS projections 17 are evenly circumferentially distributed about the tyre 10, as are the second-threshold SL projections 18. Thus, beyond each threshold SS, SL, as the tyre rotates, the projections 17, 18 come at constant time intervals into contact with the ground when the tyre is running at substantially constant speed. The tyre 10 comprises NE_{S}=3 sets each comprising two projections 17 and NE_{L}=3 sets each comprising two projections 18.

The projections 17 and 18 are also evenly circumferentially distributed about the tyre 10. Thus, beyond the threshold SL, as the tyre rotates, the projections 17 and 18 come at constant time intervals into contact with the ground when the tyre is running at substantially constant speed. The tyre 10 comprises 12 projections 17, 18 and 6 projections 17.

FIG. 2B depicts an alternative form of the tread of FIG. 2A.

In this alternative form, two circumferentially successive projections 18 are arranged at the bottom of different grooves 16 and axially offset from one another so that the second-threshold SL projections 18 are not evenly circumferentially distributed.

FIG. 3 depicts the tyre 10 of FIG. 1 when it is worn beyond the threshold SS.

The wear of the tread 12 of the tyre 10 depicted in FIG. 3 is 6 mm, i.e. above the threshold SS, or in other words greater than the distance which, when the tyre 10 is new, separates the top of the projections 17 from the surface of the tread 12. Bearing in mind the wear beyond SS, the top of the projections 17 is at the same level as the surface of the tread 12.

The tyre wear is below the threshold SL, or in other words less than the distance which, when the tyre 10 is new, separates the top of the projections 18 from the surface of the tread 12. The top of the projections 18 is at a lower level than that of the tread at this stage of wear.

Beyond the threshold SS, each projection 17 has a height less than the height h₃. Here, the height is less than 2.2 mm and is 2 mm for wear of 6 mm. This height is equal to the difference between the depth of each groove 16 and the wear of the tyre 10.

When the tyre 10 is worn beyond the threshold SS, each first-threshold SS projection 17 is designed in such a way as to come into contact with the ground as it passes through the contact area in which the tyre 10 is in contact with the ground. Therefore it emits a noise. Between the thresholds SS and SL, each second-threshold SL projection 18 is not in contact with the ground because of the space that remains between the top of each projection 18 and the ground.

FIG. 4 depicts the tyre 10 of FIGS. 1 and 2 when it is worn beyond the threshold SL.

The wear of the tread 12 of the tyre 10 that has been depicted in FIG. 4 is 7 mm, i.e. above the threshold SL, but also above the threshold SS, or in other words greater than the distance which, when the tyre 10 is new, separates the top of the projections 18 from the surface of the tread 12. Bearing in mind the wear beyond the second threshold SL, the top of the projections 18, and also that of the projections 17, is at the same level as the surface of the tread 12.

Beyond the threshold SL, each projection 17 and 18 has a height less than the height h_{L}. Here, the height is less than 1.6 mm and measures 1 mm for wear of 7 mm. This height is equal to the difference between the depth of each groove 16 and the wear of the tyre 10.

When the tyre 10 is worn beyond the threshold SL, each second-threshold SL projection 18 is designed to come into contact with the ground as it passes through the contact area in which the tyre 10 is in contact with the ground. Likewise, when the tyre 10 is worn beyond the threshold SL, each first-threshold SS projection 17 is designed to come into contact with the ground as it passes through the contact area in which the tyre 10 is in contact with the ground.

FIG. 5A depicts a development of the tread 12 of a tyre according to a second embodiment of the invention. Elements analogous to those depicted in the preceding figures are denoted by identical references.

Unlike in the tyre according to the first embodiment, two circumferentially successive first-threshold SS projections 17 are arranged in the bottom of one and the same groove 16. All the first-threshold SS projections 17 are arranged in the bottom of one and the same groove 16. The tyre comprises at most 4, and preferably at most 3, first-threshold SS projections 17.

FIG. 5B depicts an alternative form of the tread of FIG. 5A.

In this alternative form, two circumferentially successive projections 18 are arranged in the bottom of different grooves 16 and are axially offset from one another so that the second-threshold SL projections 18 are not evenly circumferentially distributed.

FIG. 6 depicts a development of the tread 12 of a tyre according to a third embodiment of the invention. Elements analogous to those depicted in the preceding figures are denoted by identical references.

Unlike in the second embodiment, the tyre 10 comprises 4 first-threshold SS projections 17 and 8 second-threshold SL projections 18.

Two circumferentially successive first-threshold SS projections 17 are arranged in the bottom of different grooves 16. Two circumferentially successive second-threshold SL projections 18 which are also situated circumferentially between two first-threshold projections 17 are arranged in the bottom of two different grooves 16. Two circumferentially successive second-threshold SL projections 18 which are also circumferentially situated on either side of one and the same first-threshold projection 17 are arranged in the bottom of that same groove 16.

FIGS. 7 and 8 depict a tyre according to a fourth embodiment of the invention. Elements analogous to those depicted in the preceding figures are denoted by identical references.

Each groove 16 is delimited by an axial wall 24 that forms the bottom of the groove 16 and two radial walls 25 that form the sides of the groove 16. Unlike in the tyre according to the first embodiment, in which the projections 18 extend wholly transversally between the two radial walls 25, i.e. from one radial wall 25 of the groove 16 containing them to the other, the projections 18 of the tyre according to the fourth embodiment extend only partially between the two radial walls 25 so that the tyre 10 comprises at least one fluidic passage canal 26 between each projection 18 and one of the walls 25 delimiting each groove 16. The canal 26 allows air or even water running along the grooves 16 to disperse.

FIG. 9 depicts a tyre according to a fifth embodiment of the invention. Elements analogous to those depicted in the preceding figures are denoted by identical references.

Unlike in the tyre according to the preceding embodiments, each projection 17 of each indicator TUS is immediately adjacent to a projection 18 of an indicator TUL.

With reference to FIG. 10 which depicts the tyre according to the sixth embodiment with tyre wear corresponding to the threshold SS, the two indicators TUS and TUL therefore form a single wear indicator TUS-TUL made up of a projection 28 arranged at the bottom of the groove 16. The projection 28 has a staircase overall shape and comprises first and second rubber parts 30, 32 respectively forming the projections 17, 18. Each first and second part 30, 32 respectively has a radially external surface 34, 36 intended to come into contact with the ground as the projection 28 passes through the contact area in which the tyre 10 is in contact with the ground. The radial dimension of the surface 34 is greater than the radial dimension of the surface 36. In other words, the height h_{S} of the first part 30 is greater than the height h_{L} of the second part 32.

FIGS. 11 and 12 depict a tyre according to a seventh embodiment of the invention. Elements analogous to those depicted in the preceding figures are denoted by identical references.

Unlike in the tyre according to the sixth embodiment, each projection 17 comprises a small acoustic cavity 38 formed in the projection 17. In this particular instance, the cavity 38 is formed in the second part 32 of the wear indicator TUS-TUL.

Beyond the threshold SS and, for preference, also beyond the threshold SL, the acoustic cavity 38 is configured in such a way as to open radially to the outside of the tyre 10 and to be closed by the ground in a substantially airtight manner as it passes through the contact area in which the tyre 10 is in contact with the ground.

The invention is not limited to the embodiments described above.

It is possible to conceive of any distribution of the projections for each threshold provided that the projections are evenly circumferentially distributed about the tyre.

It is also possible to form a cavity in the first-threshold projections when these are circumferentially separated from the second-threshold projections.

The features of the various embodiments described hereinabove may be combined provided that they are compatible with one another.

The tread may have more than two grooves.

The projections may have a variable or constant contact cross section.

The projections may run partially in the bottom of the groove or grooves and delimit a fluidic passage canal without the projections of the legal limit wear indicators extending partially at the bottom of the groove or grooves or delimiting a fluidic passage, and vice versa.

The tyre may have more than two wear thresholds. In particular the tyre may comprise several thresholds that are not as advanced as the legal limit wear threshold. For each of these thresholds, the projection or projections are evenly circumferentially distributed about the tyre.

1-15. (canceled)

16. A tyre, comprising:
plural first-threshold projections arranged circumferentially successive to each other, each first-threshold projection extending radially from a bottom portion of a circumferential groove of the tyre, and each first-threshold projection being structured such that, once the tyre has exceeded a first wear threshold, the first-threshold projection comes into contact with a ground surface when passing through a contact area in which the tyre makes contact with the ground surface; and
a second-threshold projection extending radially from a bottom portion of a circumferential groove of the tyre, the second-threshold projection being structured such that, once the tyre has exceeded a second wear threshold indicative of a more advanced wear than the first wear threshold, the second-threshold projection comes into contact with the ground surface as the second-threshold projection passes through the contact area in which the tyre makes contact with the ground surface,
wherein the plural first-threshold projections are evenly distributed circumferentially about the tyre.

17. The tyre according to claim 16, wherein the second wear threshold is a legal limit wear threshold.

18. The tyre according to claim 16 or 17, wherein the plural first-threshold projections are arranged in a bottom portion of a same circumferential groove.

19. The tyre according to claim 16 or 17, wherein the plural first-threshold projections are arranged in respective bottom portions of different circumferential grooves.

20. The tyre according to claim 16 or 17, further comprising a set of first-threshold projections arranged in respective bottom portions of different circumferential grooves, each first-threshold projection of the set being substantially axially aligned with each other first-threshold projection of the set.

21. The tyre according to claim 16 or 17, wherein projections for a same threshold are evenly distributed circumferentially about the tyre.

22. The tyre according to claim 16 or 17, wherein all of the projections are evenly distributed circumferentially about the tyre.

23. The tyre according to claim 16 or 17, wherein the projections are arranged in such a way that, whatever degree of wear of the tyre, a groove and two circumferentially successive projections of that groove delimit a space open to air as the two circumferentially successive projections pass through the contact area in which the tyre makes contact with the ground surface.

24. The tyre according to claim 16 or 17, wherein, when the tyre is new, each circumferential groove has a predetermined depth such that a height of each projection of each wear threshold is substantially equal to a difference between the predetermined depth of the groove and the wear threshold.

25. The tyre according to claim 16 or 17, wherein each projection extends partially transversally to a bottom portion of a groove such that the tyre includes a canal for fluidic passage between the projection and a wall delimiting the groove.

26. The tyre according to claim 16 or 17, wherein each first-threshold projection includes a cavity formed therein, the cavity being configured in such a way that, when the first threshold has been exceeded, the cavity:
opens radially to outside of the tyre, and
is closed by the ground surface in a substantially airtight manner as the cavity passes through the contact area in which the tyre makes contact with the ground surface.

27. The tyre according to claim 16 or 17, wherein each projection of a threshold is circumferentially separated from each projection of another threshold.

28. The tyre according to claim 16 or 17, wherein each projection of a threshold is immediately adjacent to a projection of another threshold.

29. The tyre according to claim 16 or 17, further comprising at most 12 projections, each projection being able to come into contact with the ground surface as the projection passes through the contact area in which the tyre makes contact with the ground, once the second wear threshold, which is indicative of a more advanced wear than the first wear threshold, has been exceeded.

30. The tyre according to claim 16 or 17, further comprising at most 4 first-threshold projections.
